(19) United States
(12) Patent Application Publication
(10) Pub. No.: US 2022/0036777 A1
(43) Pub. Date: Feb. 3, 2022

(54) Molded Stopper for Split-Flap Display Device

(71) Applicant: Vestaboard, Inc., Palo Alto, CA (US)

(72) Inventors: Faiza Hassan, Fairbanks, AK (US); Dorrian Porter, Menlo Park, CA (US); Ian Guyer, San Carlos, CA (US)

(21) Appl. No.: 17/300,306

(22) Filed: Jul. 30, 2020

(51) Int. Cl. G09F 11/06

(52) U.S. Cl. CPC G09F 11/06

(57) ABSTRACT

A stopper for a split-flap display device is disclosed. For instance, a split-flap bit is disclosed comprising an integrated stopper, e.g., molded as part of a housing of the split-flap bit. The stopper is molded with the housing, and stops the flaps/cards in a split-flap mechanism from turning once the motor stops for display of a specified set of flaps.

### TECHNICAL FIELD

The subject application relates to a molded stopper for a split-flap display device.

### BRIEF DESCRIPTION OF THE DRAWINGS

FIG. 1 depicts a view of an embodiment of a split-flap bit with an integrated stopper, as described herein.

FIG. 2 depicts another view of the embodiment of the split-flap bit with the integrated stopper.

FIG. 3 depicts another view of the embodiment of the split-flap bit with the integrated stopper.

FIG. 4 depicts another view of the embodiment of the split-flap bit with the integrated stopper.

FIG. 5 depicts another view of the embodiment of the split-flap bit with the integrated stopper.

FIG. 6 depicts another view of the embodiment of the split-flap bit with the integrated stopper.

FIG. 7 depicts another view of the embodiment of the split-flap bit with the integrated stopper.

FIG. 8 depicts another view of the embodiment of the split-flap bit with the integrated stopper.

FIG. 9 depicts another view of the embodiment of the split-flap bit with the integrated stopper.

FIG. 10 depicts another view of the embodiment of the split-flap bit with the integrated stopper.

### DETAILED DESCRIPTION

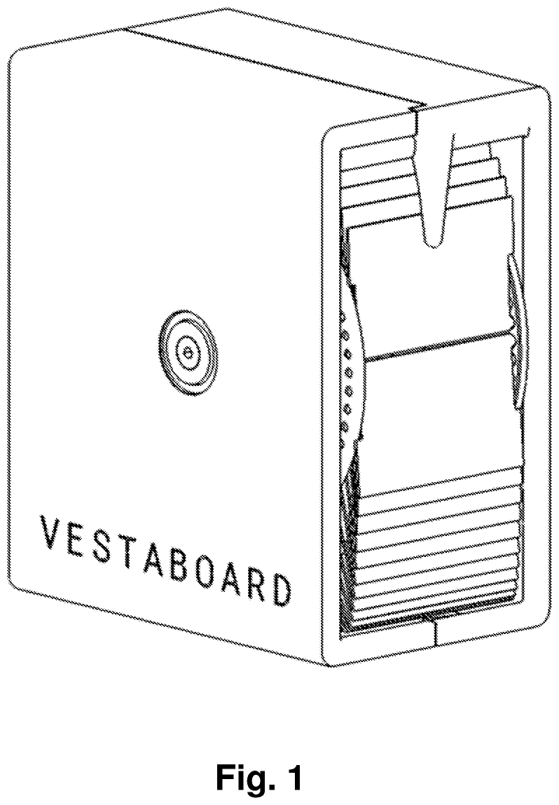

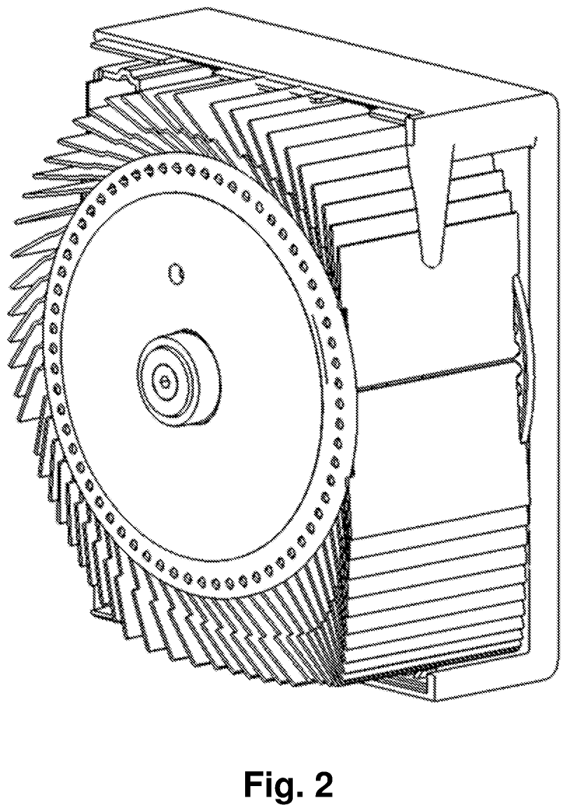

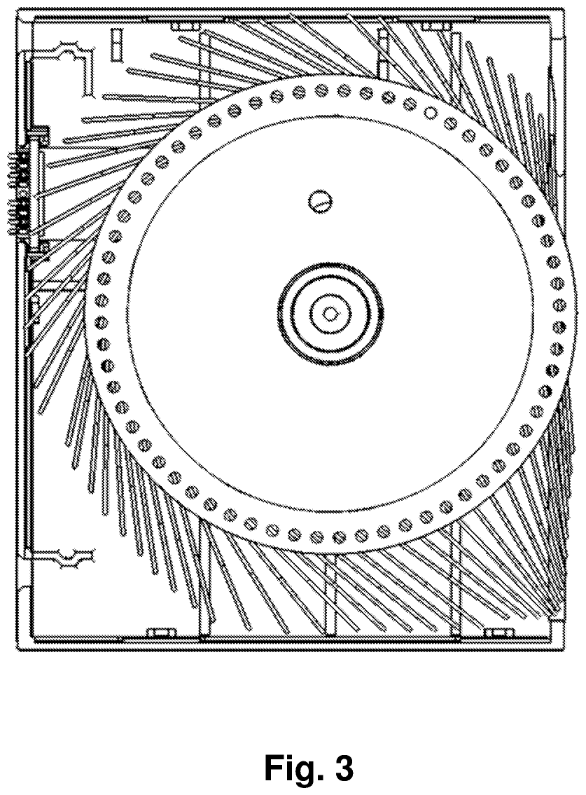

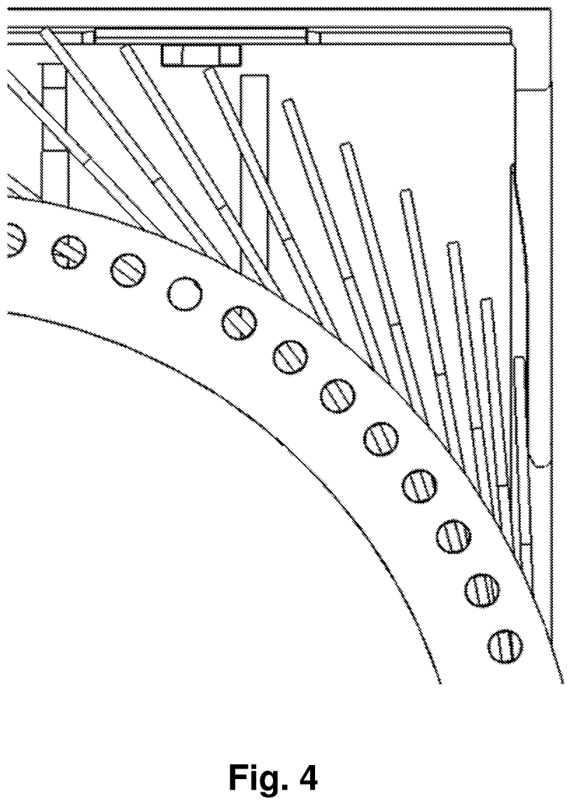

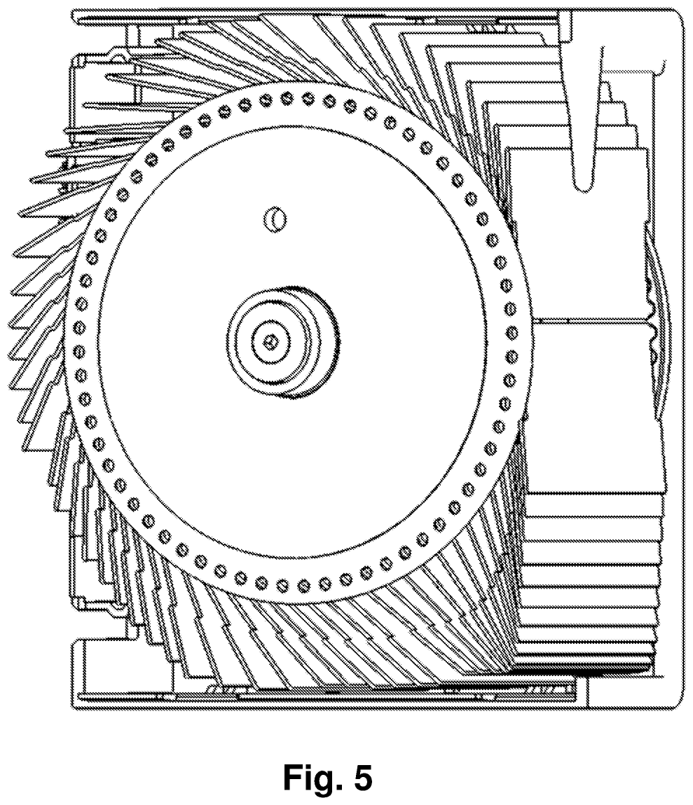

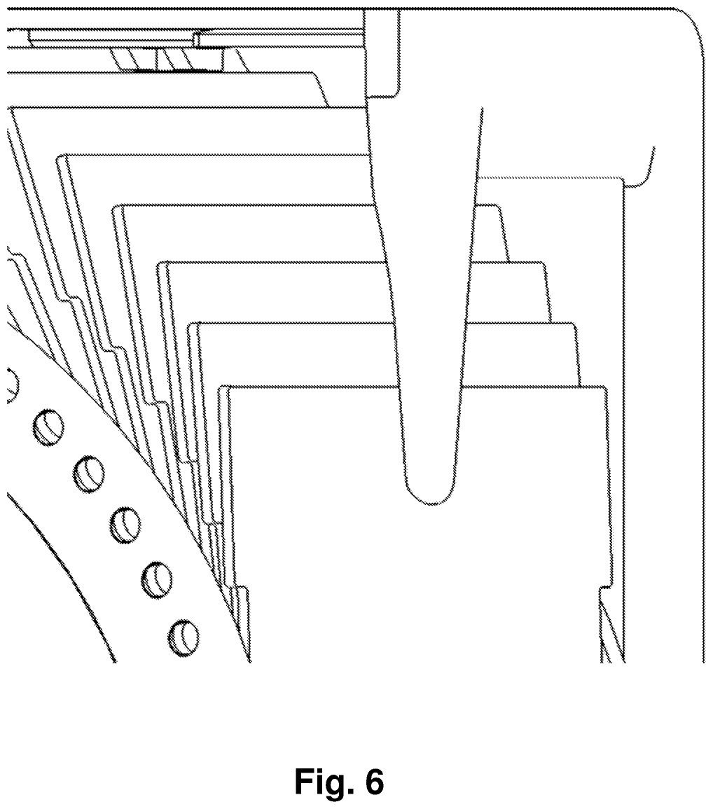

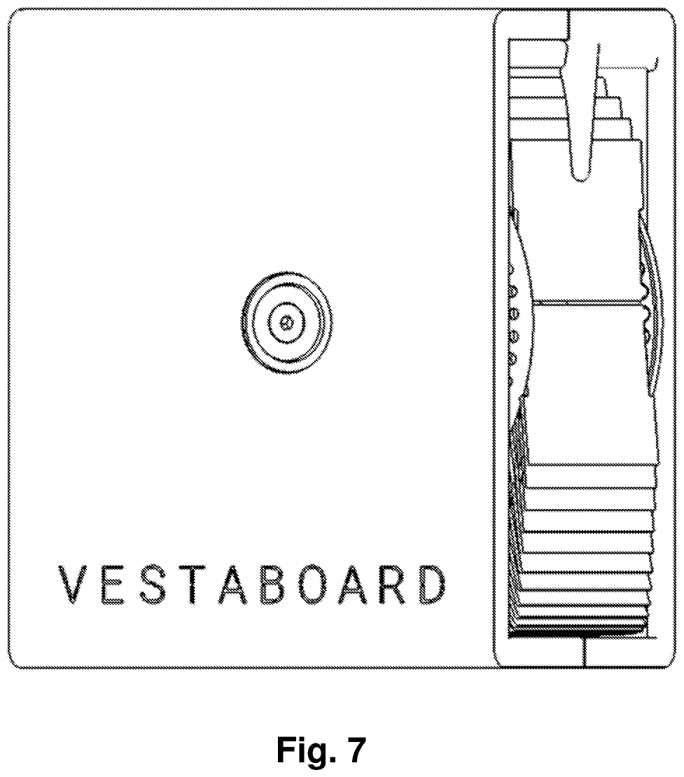

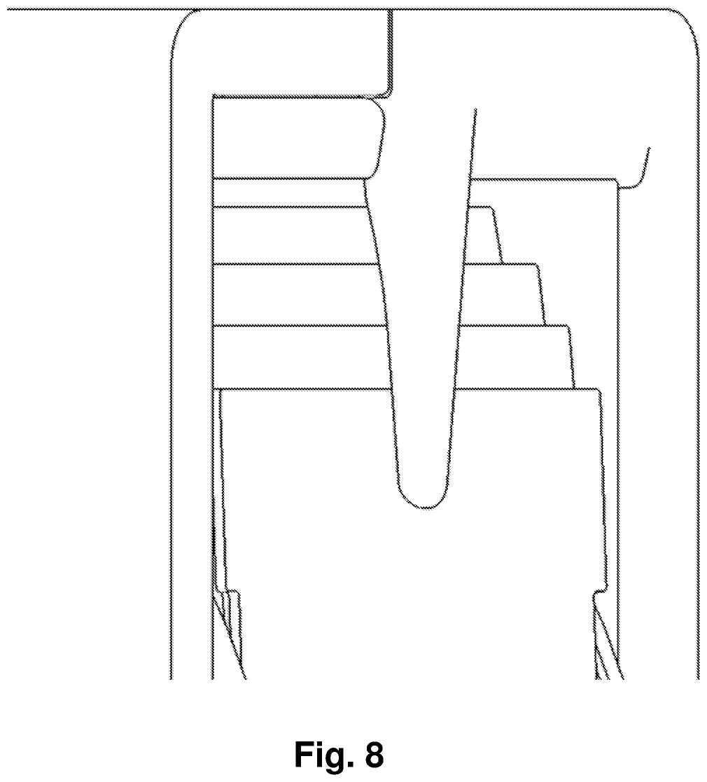

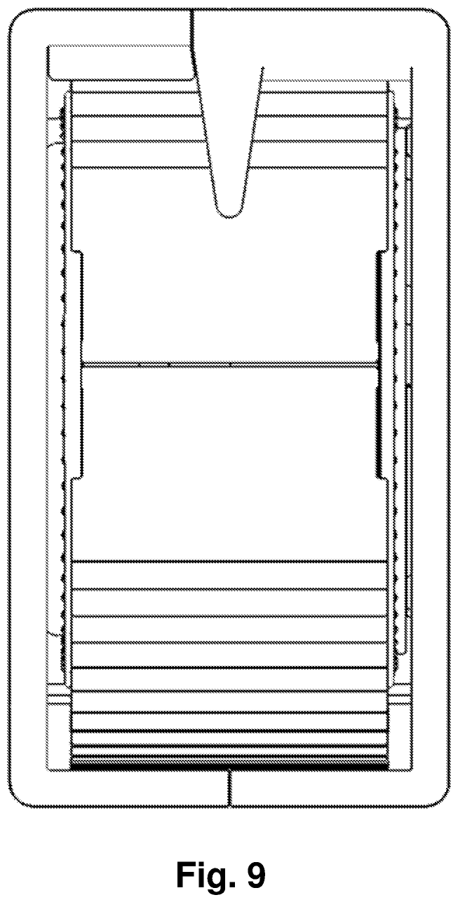

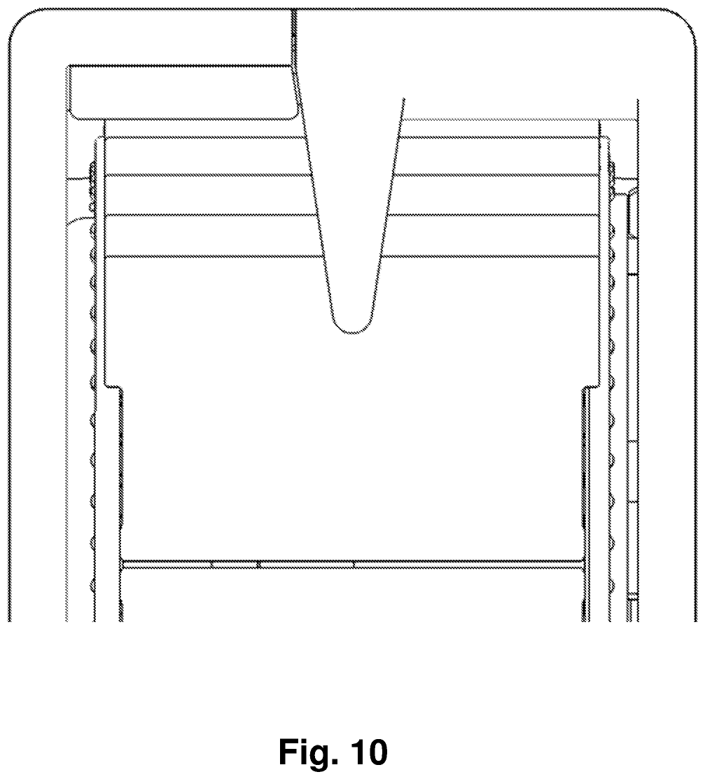

The subject embodiments relate to a split-flap bit comprising an integrated stopper, e.g., molded as part of a housing of the split-flap bit. For instance, as shown in embodiments of FIGS. 1-10 hereinbelow, the stopper is molded with the housing, and stops the flaps/cards in a split-flap mechanism from turning once the motor stops for display of a specified set of flaps. For instance, in FIG. 1, the stopper is the molded, triangular part at the top/front of the split-flap bit that hangs downward from the housing, enabling the display of a current split-flap, and preventing the advancement of a next split-flap.

The molded stopper improves ease of assembly and use, and cost of manufacturing by being an integrated part of the mechanism. The stopper begins wider at the top where integrated with the rest of the housing, and becomes narrower towards the extended or distal end of the stopper, enabling a finely tuned passing of the flaps. Together, the integrated and narrowing stopper helps create a more cost efficient split flap mechanism than would otherwise be achievable with a separate part.

1. (canceled)

2. A split-flap bit, comprising:
a housing;
a motor that operates to turn split-flaps of the split-flap bit; and
an integrated stopper integrated as part of the housing that stops a split-flap of the split-flaps after the motor stops for display of the split-flap.

3. The split-flap bit of claim 2, wherein the integrated stopper is molded as part of the housing.

4. The split-flap bit of claim 2, wherein the integrated stopper is triangular.

5. The split-flap bit of claim 2, wherein the integrated stopper is located at a top and a front of the housing of the split-flap bit.

6. The split-flap bit of claim 2, wherein the integrated stopper hangs downward from the housing.

7. The split-flap bit of claim 2, wherein the integrated stopper is wider at a top of the integrated stopper where integrated with the housing, and becomes narrower towards a distal end of the integrated stopper.

8. The split-flap bit of claim 2, wherein the integrated stopper further prevents advancement of a next split-flap after the motor stops for the display of the split-flap.
